(19) United States
(12) Patent Application Publication
(10) Pub. No.: US 2026/0051484 A1
(43) Pub. Date: Feb. 19, 2026

(54) ALL-SOLID-STATE BATTERY COMPRISING LITHIUM ALLOY ANODE

(71) Applicants: LG ENERGY SOLUTION, LTD., Seoul (KR); THE REGENTS OF THE UNIVERSITY OF CALIFORNIA, Oakland, CA (US)

(72) Inventors: Jung-Pil LEE, Daejeon (KR); Jiyoung KIM, Daejeon (KR); Yuju JEON, La Jolla, CA (US); Dong Ju LEE, La Jolla, CA (US); Zheng CHEN, San Diego, CA (US)

(73) Assignees: LG ENERGY SOLUTION, LTD., Seoul (KR); THE REGENTS OF THE UNIVERSITY OF CALIFORNIA, Oakland, CA (US)

(21) Appl. No.: 18/806,199

(22) Filed: Aug. 15, 2024

(51) Int. Cl. H01M 4/38; H01M 4/02; H01M 10/0525

(52) U.S. Cl. CPC H01M 4/382; H01M 2004/021; H01M 10/0525

(57) ABSTRACT

An all-solid-state battery is described, wherein the anode comprises an anode material comprising a product of (i) a lithium (Li) powder, and (ii) a metal selected from aluminum (Al), tin (Sn) or mixture thereof, where the product is a prelithiated metal alloy having a chemical formula of LixMy, wherein Li is lithium, M is the metal, and x and y are integers greater than 0 and where a mass ratio of the lithium to the metal is from 1:4 to 1:20, and where the anode is free of a binder material. In some aspects, the N/P ratio is from 1.00 to 2.00.

### FIELD OF TECHNOLOGY

The present disclosure relates a lithium alloy anode, as well as an all-solid-state battery comprising the lithium alloy anode and methods for making the lithium alloy anode and battery.

### BACKGROUND

There continues to be an increase in electrified transportation, exemplified by the widespread adoption of electric vehicles (EVs) and the emergence of urban air mobility (UAM) vehicles. Simultaneously, there is a growing demand for stationary energy storage systems, notably in the residential and industrial sectors, powered by solar and wind generators. This shift is driven in part by the pressing need to mitigate the adverse environmental and climate impacts associated with traditional internal combustion engines and other non-renewable means of power generation. Thus, the development of battery technologies with high energy density, while also ensuring enhanced safety, has become an imperative.

Conventional liquid lithium-ion batteries were critical to the advancement of electrified transportation and energy storage systems, and have had a significant and positive impact on green energy and climate change mitigation efforts. While such conventional liquid lithium-ion batteries are superior to many other energy sources, liquid lithium-ion batteries also have certain limitations. For example, various safety mechanisms are critical for lithium-ion batteries to restrict voltage and internal pressures, but these safety features typically result in increased weight and performance limitations in certain instances. Moreover, lithium-ion batteries are susceptible to aging, leading to capacity loss and eventually failure after a number of years of use.

In an all-solid-state battery, a solid electrolyte is used instead of a liquid electrolyte, making the entire battery solid. In a conventional solid state battery, a solid electrolyte replaces a liquid electrolyte system, and thus reduces the risk of ignition or explosion, thereby increasing safety. The solid electrolyte is intrinsically non-flammable and can accommodate a wider temperature range, allowing it to function as electrochemical energy storage without the need for additional safety devices. Solid state batteries, which offer higher energy density and are safer than batteries with a liquid electrolyte system, such as conventional lithium-ion batteries.

For example, lithium-sulfur batteries using lithium and an alkali metal as an anode active material and sulfur as a cathode active material have a theoretical energy density of 2,800 Wh/kg (1,675 mAh), which is significantly higher than those of other battery systems, and have received attention as portable electronic devices due to an advantage in that sulfur is inexpensive due to the abundance in resources, and an environmentally-friendly material. Lithium metal is advantageous because it is lightweight and has high energy density, and various cathode active materials may be used for lithium batteries, including sulfur-containing cathode active materials having sulfur-sulfur bonds, which have high energy capacities.

However, modification of metallic lithium as an anode material may be needed to address issues such as high activity, large volume deformation, and lithium dendrite problems. For instance, because metallic lithium has very high chemical activity, it may cause irreversible chemical reactions with the electrolyte, consuming electrolyte and metal lithium itself, thereby reducing the capacity of the negative electrode and battery cycle lifetime. Also, the volume deformation of lithium metal during charging and discharging is very large, resulting in greater expansion and contraction of the battery. Furthermore, the lithium metal is prone to grow lithium dendrites.

Thus, there exists a need for improved lithium materials for use as an anode material, which is suitable for use in an all-solid-state battery.

### SUMMARY

The present disclosure relates to an all-solid-state battery, where the anode comprises an anode material comprising a product of (i) a lithium (Li) powder, and (ii) a metal selected from aluminum (Al), tin (Sn) or mixture thereof, where the product is a prelithiated metal alloy having a chemical formula of LixMy, wherein Li is lithium, M is the metal, and x and y are integers greater than 0.

According to an aspect, an all-solid-state battery is provided. The all-solid-state battery comprises an anode, a cathode, and a solid electrolyte, wherein the solid electrolyte is interposed between the anode and the cathode, wherein the anode comprises an anode material comprising a product of (i) a lithium (Li) powder, and (ii) a metal selected from aluminum (Al), tin (Sn) or mixture thereof, wherein the product is a prelithiated metal alloy having a chemical formula of LixMy, wherein Li is lithium, M is the metal, and x and y are integers greater than 0, wherein a mass ratio of the lithium to the metal is from 1:4 to 1:20; and wherein the anode is free of a binder material.

In some aspects, the product may be a prelithiated metal having a chemical formula of Li_{0.25}Al, Li_{0.4}Al, Li_{0.5}Al, Li_{0.75}Al, Li_{0.5}Al, Li_{0.9}Al, or Li_{0.95}Al.

In some aspects, the product may be a prelithiated metal having a chemical formula of Li_{0.25}Sn, Li_{0.5}Sn, Li_{0.75}Sn, Li_{1.1}Sn, and Li_{2.2}Sn.

In some aspects, the lithium powder may have an average particle size of 30 μm to 60 μm.

In some aspects, the mass ratio of the lithium to the metal may be from 1:4 to 1:20.6. The mass ratio of the lithium to the metal may be from 1:4 to 1:10. The mass ratio of the lithium to the metal may be from 1:4 to 1:7.5. The mass ratio of the lithium to the metal may be from 1:4 to 1:5.

In some aspects, an N/P ratio may be from 1.00 to 2.00. The N/P ratio may be from 1.2 to 1.5.

According to another aspect, an all-solid-state battery is provided, which comprises an anode, a cathode, and a solid electrolyte, wherein the solid electrolyte is interposed between the anode and the cathode, wherein the anode comprises an anode material comprising a product of (i) a lithium (Li) powder, and (ii) a metal selected from aluminum (Al), tin (Sn) or mixture thereof, wherein the lithium powder has an average particle size of 0.1 μm to 200 μm, wherein the product is a prelithiated metal alloy having a chemical formula of LixMy, wherein Li is lithium, M is the metal, and x and y are integers greater than 0, wherein a mass ratio of the lithium to the metal is from 1:4 to 1:20, wherein an N/P ratio is from 1.00 to 3.00, and wherein the anode is free of a binder material.

In some aspects, the product may be a prelithiated metal having a chemical formula of Li_{0.25}Al, Li_{0.4}Al, Li_{0.5}Al, Li_{0.75}Al, Li_{0.5}Al, Li_{0.9}Al, or Li_{0.95}Al.

In some aspects, the product may be a prelithiated metal having a chemical formula of Li_{0.25}Sn, Li_{0.5}Sn, Li_{0.75}Sn, Li_{1.1}Sn, and Li_{2.2}Sn.

In some aspects, the lithium powder may have an average particle size of 30 μm to 60 μm.

In some aspects, the mass ratio of the lithium to the metal may be from 1:4 to 1:15.

In some aspects, the N/P ratio may be from 1.00 to 2.00.

According to another aspect, an all-solid-state battery is provided, which comprises an anode, a cathode, and a solid electrolyte, wherein the solid electrolyte is interposed between the anode and the cathode, wherein the anode comprises an anode material consisting of a product of (i) a lithium (Li) powder, and (ii) a metal selected from aluminum (Al), tin (Sn) or mixture thereof, wherein the product is a prelithiated metal alloy having a chemical formula of LixMy, wherein Li is lithium, M is the metal, and x and y are integers greater than 0, wherein a mass ratio of the lithium to the metal is from 1:4 to 1:20, and wherein the anode is free of a binder material.

In some aspects, the product may be a prelithiated metal having a chemical formula of Li_{0.25}Al, Li_{0.4}Al, Li_{0.5}Al, Li_{0.75}Al, Li_{0.5}Al, Li_{0.9}Al, or Li_{0.95}Al.

In some aspects, the product may be a prelithiated metal having a chemical formula of Li_{0.25}Sn, Li_{0.5}Sn, Li_{0.75}Sn, Li_{1.1}Sn, and Li_{2.2}Sn.

In some aspects, lithium powder may have an average particle size of 30 μm to 60 μm.

In some aspects, the mass ratio of the lithium to the metal may be from 1:4 to 1:15.

In some aspects, an N/P ratio may be from 1.00 to 2.00.

According to another aspect, a method for manufacturing the all-solid-state battery according to the above aspects is provided. The method comprises pressing an LPSCl powder to form a LPSCl separator layer, applying a NCM composite powder on a first surface of the pressed LPSCl separator layer and pressing, applying a powder composite of lithium and aluminum on a second surface of the LPSCl separator layer opposite of the first surface and pressing to form a battery cell, holding the battery cell under stack pressure in order for an alloying reaction between the lithium and aluminum to occur, and cycling the battery cell.

Each aspect may further have one or more additional elements in any combination.

### BRIEF DESCRIPTION OF THE DRAWINGS

The accompanying drawings illustrate aspects of the present disclosure, and together with the detailed disclosure, serve to provide a further understanding of the technical aspects of the present disclosure, and the present disclosure should not be construed as being limiting to the drawings. In the drawings, for clarity of description, the shape, size, scale or proportion of the elements may be exaggerated for emphasis.

FIG. 1 shows a schematic of a related art battery.

FIG. 2 shows a schematic of a battery according to a disclosed aspect.

FIG. 3 is an SEM image of lithium particles according to a disclosed aspect.

FIG. 4 is a schematic diagram of a method of manufacturing an all-solid-state battery according to a disclosed aspect.

FIG. 5 illustrates a capacity-efficiency graph for a battery cell according to an Example.

FIG. 6 illustrates the voltage profiles of the Example in FIG. 5 at various cycles.

FIG. 7 illustrates a specific capacity comparison among alloy electrodes according to Examples, and CCD screening for kinetics improvement according to Examples and a Comparative Example.

FIG. 8 illustrates a XRD patterns for Examples.

FIG. 9 illustrates CCD screening for kinetics improvement according to Examples and a Comparative Example, and an initial coulombic efficiency comparison among alloy electrodes according to Examples, and a specific capacity comparison among alloy electrodes according to Examples.

FIG. 10 illustrates CCD screening for kinetics improvement according to Examples and a Comparative Example.

FIGS. 11A and 11B illustrate capacity-efficiency graphs for battery cells according to Examples and a Comparative Example.

FIG. 12 illustrates a capacity-efficiency graph for battery cells according to Examples.

FIG. 13 illustrates XRD patterns for Examples.

### DETAILED DESCRIPTION

Hereinafter, the present disclosure will be described in detail. It should be understood that the terms or words used in the specification and the appended claims should not be construed as limited to general and dictionary meanings, but rather interpreted based on the meanings and concepts corresponding to the technical aspects of the present disclosure on the basis of the principle that the inventor is allowed to define terms appropriately for the best explanation. Therefore, the aspects of the disclosure described herein and the elements shown in the drawings are just aspects of the present disclosure, but not intended to fully describe the technical aspects of the present disclosure, so it should be understood that other equivalents and modifications could have been made thereto at the time the application was filed. Unless defined otherwise, all the technical and scientific terms used herein have the same meanings as commonly known by a person skilled in the art. In the case that there is a plurality of definitions for the terms herein, the definitions provided herein will prevail.

Unless specified otherwise, all the percentages, portions and ratios in the present disclosure are on weight basis.

Unless indicated to the contrary, the numerical parameters set forth in the following specification and attached claims are approximations that may vary depending upon the desired properties sought to be obtained according to aspects of the disclosure. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values.

While compositions and methods are described herein in terms of “comprising” various components or steps, the compositions and methods can also “consist essentially of” or “consist of” the various components and steps. The term “comprise(s)” or “include(s)” when used in this specification, specifies the presence of stated elements, but does not preclude the presence or addition of one or more other elements, unless the context clearly indicates otherwise.

The terms “about” and “substantially” are used herein in the sense of at, or nearly at, when given the manufacturing and material tolerances inherent in the stated circumstances and are used to prevent the unscrupulous infringer from unfairly taking advantage of the present disclosure where exact or absolute figures are stated as an aid to understanding the present disclosure. The terms “about” and “approximate”, when used along with a numerical variable, generally means the value of the variable and all the values of the variable within an experimental error (e.g., 95% confidence interval for the mean) or within a specified value±10% or within a broader range. Unless otherwise indicated, all numbers expressing quantities of ingredients, properties such as molecular weight, reaction conditions, and so forth used in the present specification and associated claims are to be understood may be modified by the term “about.”

“A and/or B” when used in this specification, specifies “either A or B or both.”

### <All-Solid-State Battery>

An aspect of the present disclosure relates to a solid-state battery comprising a solid electrolyte material as an electrolyte. Specific examples of the solid-state battery include any type of primary battery, secondary battery, fuel cell, solar cell or capacitor such as a super capacitor. In particular, the battery is a lithium-ion secondary battery. Aspects of the disclosure here may be implemented in a secondary battery with various form factors or battery formats, including for example in a pouch-type battery, a cylindrical battery, or a prismatic battery.

A conventional all-solid-state battery 100 is shown in FIG. 1. As shown in FIG. 1, the conventional all-solid-state battery 100 comprises a negative electrode current collector 110, positive electrode current collector 160, a negative electrode 120, a positive electrode 130, and a solid electrolyte 140 interposed between the negative electrode 120 and the positive electrode 130.

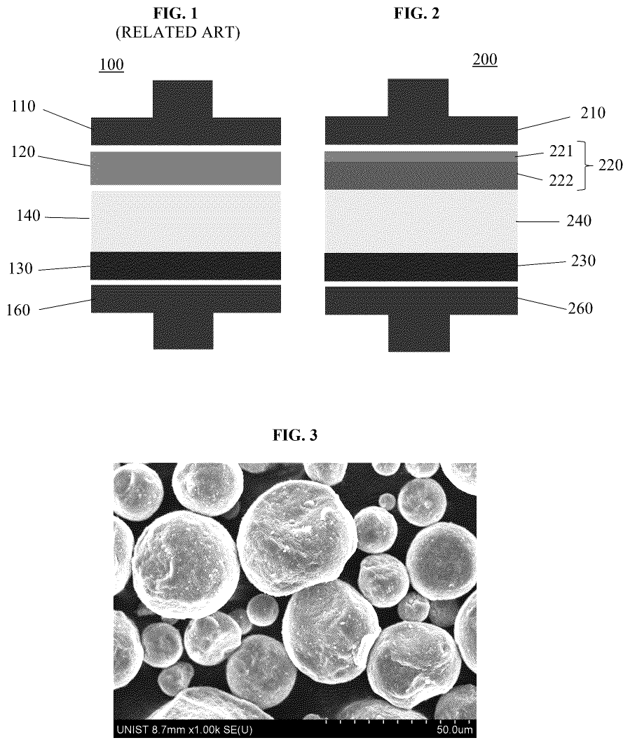

An all-solid-state battery according to disclosed aspects is shown in FIG. 2. As shown in FIG. 2, the all-solid-state battery 200 according to the present disclosure comprises an anode 220 (also referred to as a negative electrode), a cathode 230 (also referred to as a positive electrode) and a solid electrolyte 240 interposed between the negative electrode and the positive electrode. The anode 220 may include a metal portion 221 and a prelithiated metal alloy portion 222.

The electrode of the all-solid-state battery can have a structure in which an electrode active material is formed on an electrode current collector, e.g., negative electrode current collector 210 and positive electrode current collector 260. The electrode current collector may be omitted depending on the structure of the electrode. In the case in which the electrode is a negative electrode, the electrode current collector is a negative electrode current collector.

### <Anode>

The term anode is used interchangeably with the term negative electrode. The negative electrode current collector 210 is not particularly limited as long as it is conductive without causing any chemical change in the all-solid-state battery 200, and for example, copper, stainless steel, aluminum, nickel, titanium, sintered carbon, copper or stainless steel whose surface is treated with carbon, nickel, titanium, silver or the like, or aluminum-cadmium alloy, etc. can be used. Additionally, as with the positive electrode current collector 260, the negative electrode current collector 210 may include various forms such as a film, a sheet, a foil, a net, a porous body, a foam, and a nonwoven fabric having minute irregularities formed on their surfaces.

The anode 220 comprises an anode material comprising a product of (i) a lithium (Li) powder, and (ii) a metal selected from aluminum (Al), tin (Sn) or mixture thereof, where the product is a prelithiated metal alloy having a chemical formula of LixMy, wherein Li is lithium, M is the metal, and x and y are integers greater than 0.

In certain aspects, a mass ratio of the lithium to the metal may be from, for example, 1:1 to 1:100, 1:2 to 1:50, 1:3 to 1:30, 1:4 to 1:20, 1:5 to 1:10, or 1:7 to 1:9. The anode may be free of a binder material. In some aspects, a mass ratio of the lithium to the metal is from 1:4 to 1:15, and in other aspects, the mass ratio of the lithium to the metal is from 1:4 to 1:10, or the mass ratio of the lithium to the metal is from 1:4 to 1:7.5, or the mass ratio of the lithium to the metal is from 1:4 to 1:20. The disclosed range for the alloy anodes ensures effective lithium diffusion coefficient intimately relative to the battery performance. The smaller the metal ratio the alloy anodes have, the higher the lithium diffusion coefficient is obtained.

In some aspects, the product is a prelithiated metal further comprising an additional metal selected from Al, Cu, Zn, Ga, In, Ag or mixtures thereof. For example, in some aspects, the additional metal is contained in an amount from, for example, 0.01 to 50%, 0.1 to 30%, 1 to 25%, 1.5 to 10%, 2.5 to 5%, 3.0 to 4%, or 3.5 to 3.75%, by weight.

Some aspects relate to where the product is a prelithiated metal having a prelithiated Li concentration in metal in a range of, for example, 0.01 to 99.9%, 0.1 to 99.0%, 1 to 95%, 10 to 95%, 25 to 95%, 40 to 80%, or 50 to 75%. In some aspects, the prelithiated metal may have a chemical formula that includes, but is not limited to, Li_{0.25}Al, Li_{0.4} Al, Li_{0.5}Al, Li_{0.75}Al, Li₀.&Al, Li_{0.9}Al, and Li_{0.95}Al.

Some aspects relate to where the product is a prelithiated metal having a prelithiated Li concentration in metal in a range of, for example, 0.01 to 300%, 0.1 to 250%, 1 to 220%, 10 to 150%, 25 to 110%, 40 to 110%, or 50 to 99%. In some aspects, the prelithiated metal may have a chemical formula that includes, but is not limited to, Li_{0.25}Sn, Li_{0.5}Sn, Li_{0.75}Sn, Li_{1.1}Sn, and Li_{2.2}Sn.

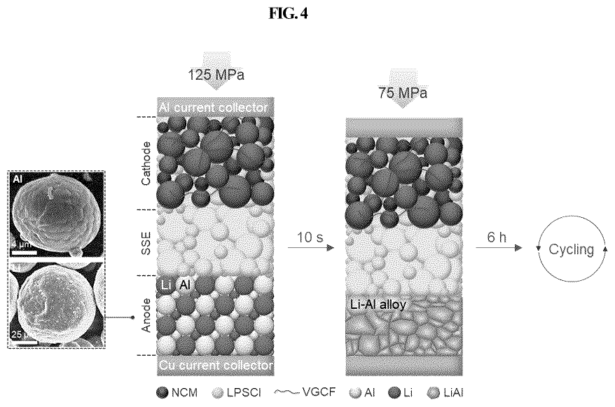

In some aspects, the lithium powder have an average particle size (D50) of, for example, 0.01 μm to 500 μm, 0.05 μm to 400 μm 0.1 μm to 200 μm, 0.5 μm to 100 μm, 1 μm to 100 μm, 10 μm to 100 μm, 25 μm to 75 μm, or 30 μm to 60 μm. In some aspects, the lithium powder may have an average particle size (D50) in a range of 30 μm to 60 μm, as shown in FIG. 3.

In some aspects, the all-solid-state battery 200 according to some aspects may have an N/P ratio in a range of, for example, 0.1 to 5.0, 0.5 to 3.0, 1.0 to 2.0, 1.2 to 2.0, 1.25 to 1.75, 1.01 to 1.10, 1.05 to 1.10, 1.01 to 1.05, or 1.5 to 2.0.

The negative electrode active material may further comprise a lithium metal, a lithium alloy, a lithium metal composite oxide, a lithium-containing titanium composite oxide (LTO), and a combination thereof. In this case, the lithium alloy may be an alloy of lithium and at least one metal selected from Na, K, Rb, Cs, Fr, Be, Mg, Ca, Sr, Ba, Ra, Al and Sn. Also, the lithium metal composite oxide may be lithium and an oxide (MeOₓ) of any one metal (Me) selected from the group consisting of Si. Sn, Zn, Mg, Cd, Ce. Ni and Fe and for example, may be LixFe₂O₃ (0≤x≤1) or LixWO₂ (0≤x≤1).

In addition, the negative electrode active material may comprise metal composite oxides such as SnₓMe₁₋ₓMe′_{y}O_{z} (Me:Mn, Fe, Pb, Ge; Me′:Al, B, P, Si, elements of groups 1, 2 and 3 of the periodic table, halogen; 0<x=1; 1=y=3; 1=z=8); oxides such as SnO, SnO₂, PbO, PbO₂, Pb₂O₃, Pb₂O₄, Sb₂O₃, Sb₂O₄, Sb₂O₅, GeO, GeO₂, Bi₂O₃, Bi₂O₄ and Bi₂O₅, and carbon-containing negative electrode active materials such as crystalline carbon, amorphous carbon or carbon composite may be used alone or in combination of two or more.

### <Cathode>

The term cathode is used interchangeably with the term positive electrode. The positive electrode current collector 260 can be used, and is not particularly restricted, as long as the positive electrode current collector 260 exhibits high conductivity while the positive electrode current collector 260 does not induce any chemical change in the battery 200 to which the positive electrode current collector is applied. For example, the positive electrode current collector 260 may be made of stainless steel, aluminum, nickel, titanium, or plastic carbon. Alternatively, the positive electrode current collector 260 may be made of aluminum or stainless steel, the surface of which is treated with carbon, nickel, titanium, or silver.

The positive electrode current collector 260 is not limited to a particular type and may include those having high conductivity without causing a chemical change in the corresponding battery, for example, stainless steel, copper, aluminum, nickel, titanium, sintered carbon, or aluminum or stainless steel treated with carbon, nickel, titanium and silver on the surface.

A positive electrode active material includes an excellent positive electrode active material particle for sulfide-based all-solid-state batteries, the surface of which is reformed, according to the present disclosure. In addition, an additional material may be used depending on what a lithium secondary battery is used for. For example, a transition-metal-compound-based active material or a sulfide-based active material may be used.

Some aspects relate to wherein the cathode 230 further comprises a positive electrode material, a solid electrolyte and a conductive agent. In some aspects, the positive electrode material comprises a lithium nickel manganese cobalt oxide (hereinafter referred to as NMC, Li-NMC, LNMC, or NCM), which are mixed metal oxides of lithium, nickel, manganese and cobalt with the general formula LiNiₓMn_{y}Co₁₋ₓ₋ₓO₂. In some aspects, the positive electrode material comprises at least one of LiCoO₂, LiMn₂O₄, LiMnO₂, or LiNiO₂. In some aspects, the positive electrode material comprises sulfur.

### <Solid Electrolyte>

For purposes of the solid electrolyte 240 interposed between the negative electrode 220 and the positive electrode 240 in the all-solid-state battery 210, any suitable sulfide-containing electrolyte material may be used. As used here, “sulfide-based electrolyte” refers to an electrolyte that includes inorganic materials containing S which conduct ions (e.g., Li⁺), and which are suitable for electrically insulating the positive and negative electrodes of an electrochemical cell. Exemplary sulfide-containing electrolytes are set forth in Shaojie Chen et al., “Sulfide solid electrolytes for all-solid-state lithium batteries: Structure, conductivity, stability and application,” Energy Storage Materials, Volume 14, Pages 58-74 (September 2018), which is hereby expressly incorporated by reference in its entirety.

For example, many sulfide-containing electrolyte materials are particularly attractive due to their superionic conductivities (as high as ˜10⁻² S cm⁻¹) and deformability. In particular, Li₃P₇S₁₁, Li₁₀GeP₂S₁₂, and Na₃PS₄ and Li₆PS₅Cl have been reported to exhibit high ionic conductivities; some even close to those of liquid electrolytes. According to aspects of the disclosure, the sulfide solid electrolyte materials also provide a low Young's modulus, which is beneficial for producing favorable interface contacts with electrode materials by simple cold pressing at room temperature.

The sulfide-containing solid electrolyte, according to aspects of the disclosure, may contain sulfur(S) and have the ionic conductivity of metal belonging to Group I or II in the periodic table, e.g., Li⁺. Additionally, in an aspect of the present disclosure, the selected solid electrolyte has the ionic conductivity of 1×10⁻⁵ S/cm, or according to some aspects of the disclosure, 1×10⁻³ S/cm or more.

Non-limiting examples of the sulfide-containing solid electrolyte may include Li—P—S-based glass, Li—P—S-based glass ceramic and argyrodite-based sulfide-containing solid electrolyte.

Non-limiting examples of the sulfide-containing solid electrolyte may include at least one of xLi₂S-yP₂S₅, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂ or Li₂S—GeS₂—ZnS, Li6PS5X (X=at least one of Cl, Br or I).

In an aspect of the present disclosure, the sulfide-containing solid electrolyte may comprise at least one selected from LPS-based glass or glass ceramic such as xLi₂S-yP₂S₅, or an argyrodite-based sulfide-containing solid electrolyte (Li₆PS₅X; X═Cl, Br, I).

In another aspect, the solid electrolyte 240 may include a solid electrolyte commonly used in the all-solid-state battery, such as an inorganic solid electrolyte or an organic solid electrolyte may be used.

In the case of the inorganic solid electrolyte, a ceramic material, a crystalline material or an amorphous material may be used. For instance, inorganic solid electrolytes such as thio-LISICON (Li_{3.25}Ge_{0.25}P_{0.75}S₄), Li₂S—SiS₂, LiI—Li₂S—SiS₂, LiI—Li₂S—P₂S₅, LiI—Li₂S—P₂O₅, LiI—Li₃PO₄—P₂S₅, Li₂S—P₂S₅, Li₃PS₄, Li₇P₃S₁₁, Li₂O—B₂O₃, Li₂O—B₂O₃—O₅, Li₂O—V₂O₅—SiO₂, Li₂O—B₂O₃, Li₃PO₄, Li₂O—Li₂WO₄—B₂O₃, LiPON, LiBON, Li₂O—SiO₂, LiI, Li₃N, Li₅La₃Ta₂O₁₂, Li₇La₃Zr₂O₁₂, Li₆BaLa₂Ta₂O₁₂, Li₃PO_{f4-3/2w)}Nw (wherein w is w<D), and Li_{3.6}Si_{0.6}P_{0.4}O₄ can be used.

The average size of sulfide-based particles is, for example, 0.1 μm to 50 μm, or 0.5 μm to 20 μm, which is within the size range of sulfide-based particles used in well-known all-solid-state batteries. In the case in which the average size of the sulfide-based particles is less than the above range, the sulfide-based particles may form lumps. In the case in which the average size of the sulfide-based particles is greater than the above range, on the other hand, the porosity of the manufactured solid electrolyte is high, whereby the characteristics of the battery may be deteriorated. For example, the capacity of the battery may be reduced.

The sulfide-based particle may have an ion conductivity of 1×10⁻⁴ S/cm or more, or the sulfide-based particle may have an ion conductivity of 1×10⁻³ S/cm or more.

In addition to the above-mentioned sulfide-based solid electrolytes, other well-known solid electrolytes may also be used. For example, an inorganic solid electrolyte, such as Li₂O—B₂O₃, Li₂O—B₂O₃—P₂O₅, Li₂O—V₂O₅—SiO₂, Li₃PO₄, Li₂O—Li₂WO₄—B₂O₃, LiPON, LiBON, Li₂O—SiO₂, LiI, Li₃N, Li₅La₃ Ta₂O₁₂, Li₇La₃Zr₂O₁₂, Li₆BaLa₂Ta₂O₁₂, Li₃PO_{(4-3/2w)}N_{w} (w<1), or Li_{3.6}Si_{0.6}P_{0.4}O₄, may be used.

In addition, examples of the organic solid electrolyte include organic solid electrolytes prepared by mixing lithium salt to polymeric materials such as polyethylene derivatives, polyethylene oxide derivatives, polypropylene oxide derivatives, phosphate ester polymers, agitation lysine, polyester sulfide, polyvinyl alcohol, and polyvinylidene fluoride. In this case, these may be used alone or in combination of at least one.

The above-described coated sulfide-containing electrolyte material can be used for a solid electrolyte for an all-solid-state battery. The all-solid-state battery contains a positive electrode, a negative electrode, with the solid electrolyte interposed therebetween.

### <Manufacturing>

The method for manufacturing the all-solid-state battery 200 according to the present disclosure is not particularly limited and may be any suitable method known in the art. For example, the all-solid-state battery 200 may be manufactured through a dry compression process, in which an electrode powder and solid electrolyte powder are manufactured, introduced into a predetermined mold, and pressed, or a slurry coating process, in which a slurry composition including an active material, a solvent, and a binder is manufactured, coated on a current collector, and dried. In the present disclosure, the method of manufacturing the all-solid-state battery 200 may include, but is not limited to, in situ prelithiation of pure Al with Li powder in a cell assembly procedure, as illustrated in FIG. 4.

As seen in FIG. 4, this in situ prelithiation method may include pressing LPSCl powder (e.g., 70 mg at 312 MPa for 10 seconds) to make a separator layer, spreading a desired amount of NCM composite powder on a side of the pressed LPSCl layer, and pressing the LPSCl layer (e.g., at 380 MPa for 3 minutes). The method may include preparing a powder composite of lithium and aluminum with a desired mass ratio for LiₓAl₁ and spreading on the other side of the LPSCl layer and pressing (e.g., at 125 MPa for 10 seconds). The resulting cell may then be held at rest at a specified stack pressure (e.g., 75 MPa for 6 hours) for the complete alloying reaction between the lithium and aluminum, followed by cell cycling.

As another example, the solid electrolyte 240 may be disposed between the positive electrode 230 and the negative electrode 220, and then the same is compressed in order to assemble a cell. The assembled cell is mounted in a sheathing member, and then the sheathing member is encapsulated by heating and compression. A laminate case made of aluminum or stainless steel, a cylindrical metal container, or a prismatic metal container may be appropriately used as the sheathing member.

The respective electrode slurry may be coated on the corresponding current collector using a method of placing the electrode slurry on the current collector and uniformly dispersing the electrode slurry with a doctor blade, a die casting method, a comma coating method, or a screen printing method. Alternatively, the electrode slurry and the current collector may be formed on a separate substrate, and the electrode slurry and the current collector may be joined to each other through pressing or lamination. At this time, the concentration of a slurry solution or the number of coatings may be adjusted in order to adjust the final coating thickness.

The drying process is a process of removing the solvent or moisture from the slurry in order to dry the slurry coated on the metal current collector. The drying process may vary depending on the solvent that is used. For example, the drying process may be performed in a vacuum oven having a temperature of 50° C. to 200° C. For example, drying may be performed using a warm-air drying method, a hot-air drying method, a low-humidity-air drying method, a vacuum drying method, a (far-) infrared drying method, or an electron beam radiation method. The drying time is not particularly restricted. In general, drying is performed within a range of 30 seconds to 24 hours.

After the drying process, a cooling process may be further performed. In the cooling process, slow cooling to room temperature may be performed such that the recrystallized structure of the binder is sufficiently formed.

In addition, if necessary, a rolling process, in which the electrode is passed through a gap between two heated rolls such that the electrode is compressed so as to have a desired thickness, may be performed in order to increase the capacity density of the electrode and to improve adhesion between the current collector and the active material after the drying process. In the present disclosure, the rolling process is not particularly restricted. A well-known rolling process, such as pressing, may be performed. For example, the electrode may pass through a gap between rotating rolls, or a flat press machine may be used to press the electrode.

### EXAMPLES

The following examples are not intended to be limiting. The above disclosure provides many different aspects for implementing the features of the disclosure, and the following examples describe certain aspects. It will be appreciated that other modifications and methods known to one of ordinary skill in the art can also be applied to the following experimental procedures, without departing from the scope of the disclosure.

### Experiment 1

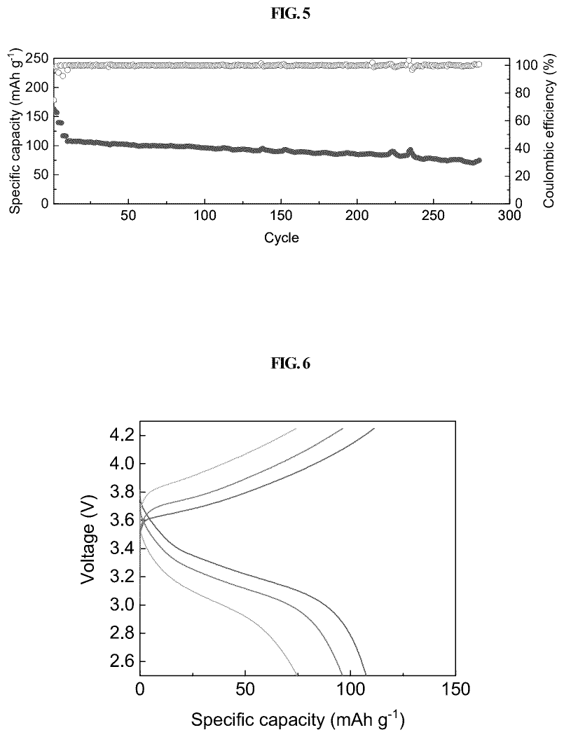

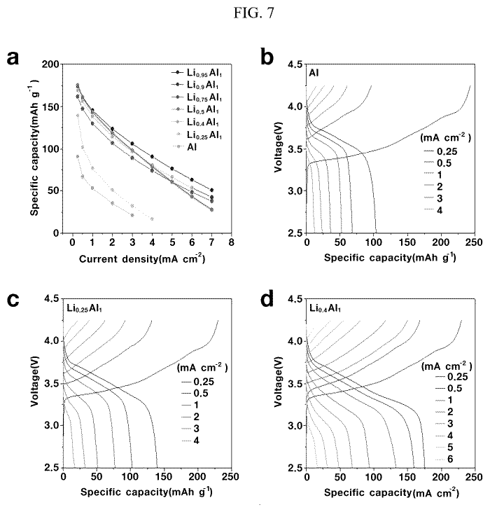

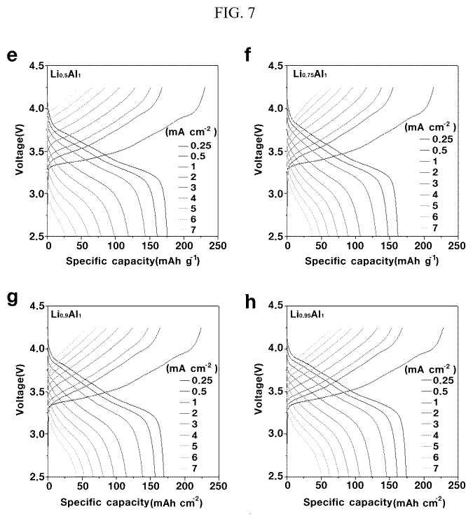

A battery cell (Example 1) including a pre-lithiated metal anode (Li_{0.25}Al₁), a cathode (NCM), and an electrolyte material (LiPSCl), and having an NP ratio of 1.2 and a C-rate: 1.2 C (1 C=2.5 mAh cm⁻²) was tested for capacity and columbic efficiency under conditions of a stack pressure of 75 MPa and at room temperature. FIG. 5 shows a graph of specific capacity (mAh g⁻¹) and columbic efficiency (%) versus cycle number for Example 1. As shown in FIG. 5, the capacity retention was 70% for up to 280 cycles. FIG. 6 illustrates the voltage profiles of Example 1 at the 10^{th}, 100^{th}, and 280^{th} cycle from the cyclability in FIG. 5. As seen in FIG. 6, cell performance is maintained even at high cycles, e.g., 280.

### Experiment 2

Battery cells including a cathode (NCM), an electrolyte material (LiPSCl), and the anodes listed in Table 1 below having an N/P ratio of 2.0 and various C-rates: 0.1 C, 0.2 C, 0.4 C, 0.8 C, 1.2 C, 1.6 C, 2 C, 2.4 C and 2.8 C (1C=2.5 mAh cm⁻²) were tested for capacity and columbic efficiency under conditions of a stack pressure of 75 MPa and at room temperature.

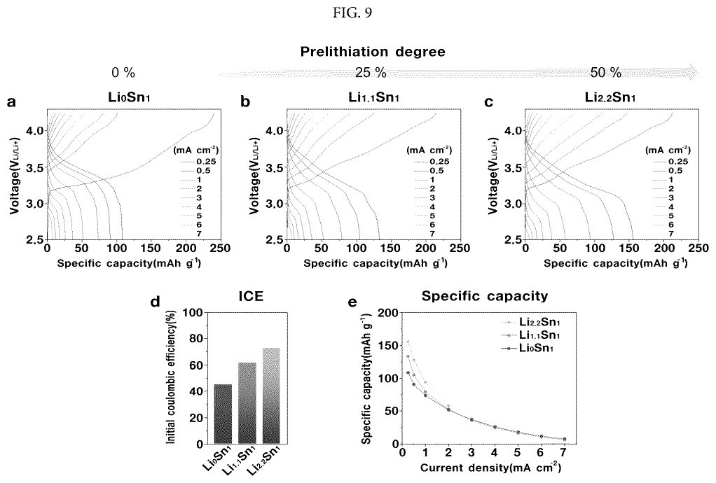

TABLE 1

| Sample | Anode | Figure |
|---|---|---|
| Example 2 | Li & Al (Li 25%) | FIG. 7C |
| Example 3 | Li & Al (Li 40%) | FIG. 7D |
| Example 4 | Li & Al (Li 50%) | FIG. 7E |
| Example 5 | Li & Al (Li 75%) | FIG. 7F |
| Example 6 | Li & Al (Li 90%) | FIG. 7G |
| Example 7 | Li & Al (Li 95%) | FIG. 7H |
| Example 8 | Li & Sn (Li 110%) | FIG. 9B |
| Example 9 | Li & Sn (Li 220%) | FIG. 9C |
| Comparative Example 1 | Al | FIG. 7B |
| Comparative Example 2 | Sn | FIG. 9A |

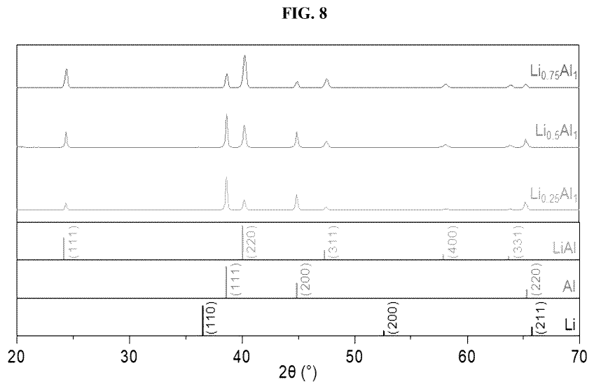

XRD and CCD tests were conducted using a powder type mixing ball. FIG. 7A illustrates a specific capacity comparison among LiₓAl₁ alloy electrodes at various current densities. FIGS. 7B-7H show the CCD screening for the kinetics improvement of LiₓAl₁ alloy electrodes along with prelithiation degree increase at N/P ratio 2 for Examples 2-7 and Comparative Example 1. FIG. 8 illustrates the XRD patterns for Example 2 (Li_{0.25}Al₁), Example 4 (Li_{0.5}Al₁), and Example 5 (Li_{0.75}Al₁). FIGS. 9A-9C show the CCD screening for the kinetics improvement of LiₓSn₁ alloy electrodes along with prelithiation degree increase at N/P ratio 2 for Examples 8 and 9 and Comparative Example 2. FIG. 9D illustrates initial coulombic efficiency comparison among LiₓSn₁ alloy electrodes. FIG. 9E illustrates a specific capacity comparison among LiₓSn₁ alloy electrodes at each current density. As seen in FIGS. 7-9, Examples 2-9 exhibited superior critical current density compared to Comparative Examples 1 and 2.

### Experiment 3

Battery cells including a cathode (NCM), an electrolyte material (LiPSCl), and the anodes and various N/P ratios listed in Table 2 below and various C-rates: 0.1 C, 0.2 C, 0.4 C, 0.8 C, 1.2 C, 1.6 C, 2 C, 2.4 C and 2.8 C (1C=2.5 mAh cm⁻²) were tested for capacity and columbic efficiency under conditions of a stack pressure of 75 MPa and at room temperature.

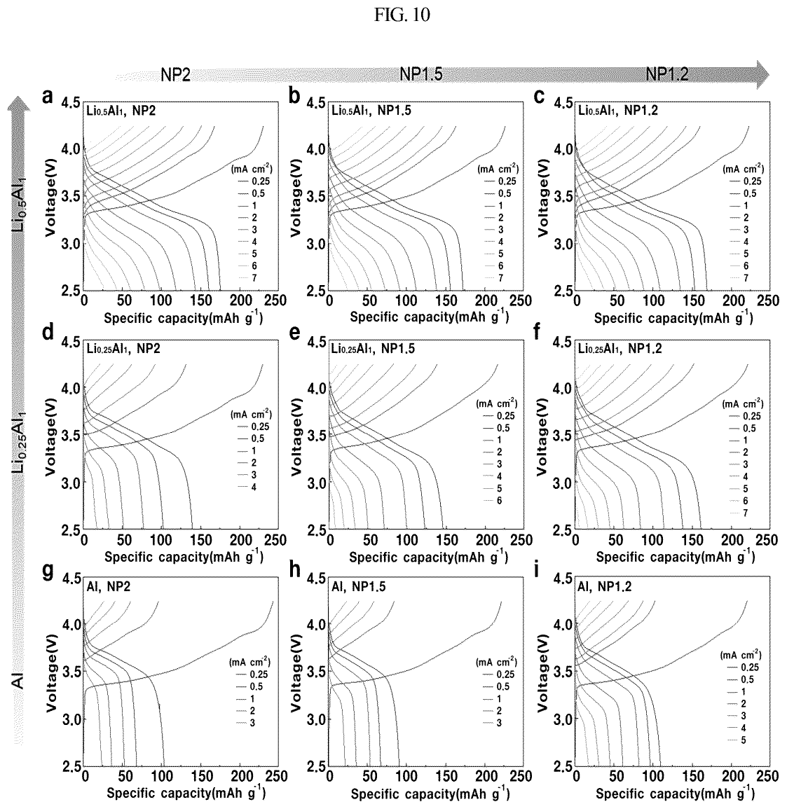

TABLE 2

| Sample | Anode | NP Ratio | Figure |
|---|---|---|---|
| Example 10 | Li & Al (Li 50%) | 2 | FIG. 10A |
| Example 11 | Li & Al (Li 50%) | 1.5 | FIG. 10B |
| Example 12 | Li & Al (Li 50%) | 1.2 | FIG. 10C |
| Example 13 | Li & Al (Li 25%) | 2 | FIG. 10D |
| Example 14 | Li & Al (Li 25%) | 1.5 | FIG. 10E |
| Example 15 | Li & Al (Li 25%) | 1.2 | FIG. 10F |
| Comparative Example 3 | Al | 2 | FIG. 10G |
| Comparative Example 4 | Al | 1.5 | FIG. 10H |
| Comparative Example 5 | Al | 1.2 | FIG. 10I |

CCD tests were conducted using a powder type mixing ball. FIGS. 10A-10I show the CCD screening for the kinetics improvement of electrodes for Examples 10-15 and Comparative Examples 3-5. As seen in FIGS. 10A-10I, Examples 10-15 exhibited superior critical current density compared to Comparative Examples 3-5.

### Experiment 4

Battery cells including a cathode (NCM), an electrolyte material (LiPSCl), and the anodes and various N/P ratios listed in Table 3 below and a C-rate: 1.2 C (1 C=2.5 mAh cm⁻²) were tested for capacity and columbic efficiency under conditions of a stack pressure of 75 MPa and at room temperature.

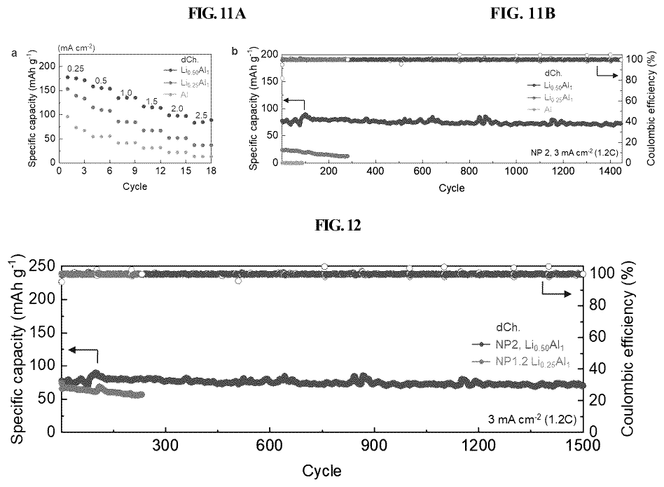

TABLE 3

| Sample | Anode | NP Ratio | Figure(s) |
|---|---|---|---|
| Example 16 | Li & Al (Li 50%) | 2 | FIGS. 11A & 11B |
| Example 17 | Li & Al (Li 25%) | 2 | FIGS. 11A & 11B |
| Comparative | Al | 2 | FIGS. 11A & 11B |
| Example 6 | | | |
| Example 18 | Li & Al (Li 50%) | 2 | FIG. 12 |
| Example 19 | Li & Al (Li 25%) | 1.2 | FIG. 12 |

FIGS. 11A and 11B show graphs of specific capacity (mAh g⁻¹) (FIG. 11A) and specific capacity (mAh g⁻¹) and columbic efficiency (%) (FIG. 11B) versus cycle number for Examples 16 and 17 and Comparative Example 6. As shown in FIGS. 11A and 11B, the capacity retention was 82% for up to 1446 cycles for Example 16, whereas Example 17 shorted out after about 280 cycles and Comparative Example 6 shorted out after about 88 cycles. As shown in FIG. 12, the capacity retention was 79% for up to 1500 cycles for Example 18, whereas Example 19 shorted out after about 232 cycles. These results illustrate the superior cyclability of Examples 16-19 compared to Comparative Example 6, and the further superior cyclability of Examples 16 and 18 compared to Examples 17 and 19.

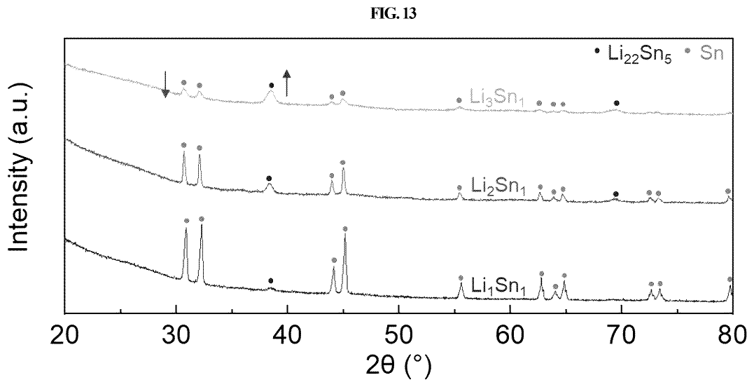

FIG. 13 illustrates the XRD patterns for Example 20 (Li₃Sn₁), Example 21 (Li₂Sn₁), and Example 22 (Li₁Sn₁). As seen in FIG. 13, Example 20 has a more suitable crystal structure compared to Examples 21 and 22 for enhancing critical current density.

It will be understood by those of ordinary skill in the art that aspects of the present disclosure can be performed within a wide equivalent range of parameters without affecting the scope of the disclosure described herein. All publications, patent applications and patents disclosed herein are incorporated by reference in their entirety.

What is claimed is:

1. An all-solid-state battery, comprising an anode, a cathode, and a solid electrolyte,
wherein the solid electrolyte is interposed between the anode and the cathode,
wherein the anode comprises an anode material comprising a product of (i) a lithium (Li) powder, and (ii) a metal selected from aluminum (Al), tin (Sn) or mixture thereof;
wherein the product is a prelithiated metal alloy having a chemical formula of LixMy, wherein Li is lithium, M is the metal, and x and y are integers greater than 0;
wherein a mass ratio of the lithium to the metal is from 1:4 to 1:20; and
wherein the anode is free of a binder material.

2. The all-solid-state battery according to claim 1, wherein the product is a prelithiated metal having a chemical formula of Li_{0.25}Al, Li_{0.4}Al, Li_{0.5}Al, Li_{0.75}Al, Li_{0.5}Al, Li_{0.9}Al, or Li_{0.95}Al.

3. The all-solid-state battery according to claim 1, wherein the product is a prelithiated metal having a chemical formula of Li_{0.25}Sn, Li_{0.5}Sn, Li_{0.75}Sn, Li_{1.1}Sn, and Li_{2.2}Sn.

4. The all-solid-state battery according to claim 1, wherein the lithium powder has an average particle size of 30 μm to 60 μm.

5. The all-solid-state battery according to claim 1, wherein the mass ratio of the lithium to the metal is from 1:4 to 1:20.

6. The all-solid-state battery according to claim 1, wherein an N/P ratio is from 1.00 to 2.00.

7. The all-solid-state battery according to claim 1, wherein an N/P ratio is from 1.2 to 1.5.

8. An all-solid-state battery, comprising an anode, a cathode, and a solid electrolyte,
wherein the solid electrolyte is interposed between the anode and the cathode,
wherein the anode comprises an anode material comprising a product of (i) a lithium (Li) powder, and (ii) a metal selected from aluminum (Al), tin (Sn) or mixture thereof;
wherein the lithium powder has an average particle size of 0.1 μm to 200 μm;
wherein the product is a prelithiated metal alloy having a chemical formula of LixMy, wherein Li is lithium, M is the metal, and x and y are integers greater than 0;
wherein a mass ratio of the lithium to the metal is from 1:4 to 1:20;
wherein an N/P ratio is from 1.00 to 3.00; and
wherein the anode is free of a binder material.

9. The all-solid-state battery according to claim 8, wherein the product is a prelithiated metal having a chemical formula of Li_{0.25}Al, Li_{0.4}Al, Li_{0.5}Al, Li_{0.75}Al, Li_{0.5}Al, Li_{0.9}Al, or Li_{0.95}Al.

10. The all-solid-state battery according to claim 8, wherein the product is a prelithiated metal having a chemical formula of Li_{0.25}Sn, Li_{0.5}Sn, Li_{0.75}Sn, Li_{1.1}Sn, and Li_{2.2}Sn.

11. The all-solid-state battery according to claim 8, wherein the lithium powder has an average particle size of 30 μm to 60 μm.

12. The all-solid-state battery according to claim 8, wherein the mass ratio of the lithium to the metal is from 1:4 to 1:15.

13. The all-solid-state battery according to claim 8, wherein the N/P ratio is from 1.00 to 2.00.

14. An all-solid-state battery, comprising an anode, a cathode, and a solid electrolyte,
wherein the solid electrolyte is interposed between the anode and the cathode,
wherein the anode comprises an anode material consisting of a product of (i) a lithium (Li) powder, and (ii) a metal selected from aluminum (Al), tin (Sn) or mixture thereof;
wherein the product is a prelithiated metal alloy having a chemical formula of LixMy, wherein Li is lithium, M is the metal, and x and y are integers greater than 0;
wherein a mass ratio of the lithium to the metal is from 1:4 to 1:20; and
wherein the anode is free of a binder material.

15. The all-solid-state battery according to claim 14, wherein the product is a prelithiated metal having a chemical formula of Li_{0.25}Al, Li_{0.4}Al, Li_{0.5}Al, Li_{0.75}Al, Li_{0.5}Al, Li_{0.9}Al, or Li_{0.95}Al.

16. The all-solid-state battery according to claim 14, wherein the product is a prelithiated metal having a chemical formula of Li_{0.25}Sn, Li_{0.5}Sn, Li_{0.75}Sn, Li₁.Sn, and Li_{2.2}Sn.

17. The all-solid-state battery according to claim 14, wherein the lithium powder has an average particle size of 30 μm to 60 μm.

18. The all-solid-state battery according to claim 14, wherein the mass ratio of the lithium to the metal is from 1:4 to 1:15.

19. The all-solid-state battery according to claim 14, wherein an N/P ratio is from 1.00 to 2.00.

20. A method for manufacturing the all-solid-state battery according to claim 1, the method comprising:
pressing an LPSCl powder to form a LPSCl separator layer;
applying a NCM composite powder on a first surface of the pressed LPSCl separator layer and pressing;
applying a powder composite of lithium and aluminum on a second surface of the LPSCl separator layer opposite of the first surface and pressing to form a battery cell;
holding the battery cell under stack pressure in order for an alloying reaction between the lithium and aluminum to occur; and
cycling the battery cell.
